(19) United States
(12) Patent Application Publication
(10) Pub. No.: US 2013/0273387 A1
(43) Pub. Date: Oct. 17, 2013

(54) High-Frequency Welding of Sandwich Metal Sheets

(71) Applicants: Axel Joachim Kleier, Gelsenkirchen (DE); Stefan Wischman, Berlin (DE); Jens Plha, Dusseldorf (DE)

(72) Inventors: Axel Joachim Kleier, Gelsenkirchen (DE); Stefan Wischman, Berlin (DE); Jens Plha, Dusseldorf (DE)

(73) Assignee: ThyssenKrupp Steel Europe AG, Duisburg (DE)

(21) Appl. No.: 13/919,631

(22) Filed: Jun. 17, 2013

Related U.S. Application Data
(63) Continuation of application No. PCT/EP2011/073228, filed on Dec. 19, 2011.

(30) Foreign Application Priority Data
Dec. 21, 2010 (DE) 102010061454.8

(51) Int. Cl. B23K 9/00; B32B 15/08

(52) U.S. Cl. CPC B23K 9/00; B32B 15/08
USPC 428/577; 219/137 R; 181/284

(57) ABSTRACT

The invention relates to a method for welding a first composite sheet metal part comprising at least two metal sheets and a sheet arranged between both metal sheets that consists of a material with a different chemical composition than the two metal sheets, to a second sheet metal part consisting of a solid metallic material or a further composite material with at least two metal sheets and a sheet arranged between the metal sheets that consists of a material with a different chemical composition than the two metal sheets. The object of providing a method for welding composite sheet metal parts is achieved by welding the sheet metal parts using a high-frequency welding method.

### CROSS-REFERENCE TO RELATED PATENT APPLICATIONS

This patent application is a continuation of PCT/EP2011/073228, filed Dec. 19, 2011, which claims priority to German Application No. 102010061454.8, filed Dec. 21, 2010, the entire teachings and disclosure of which are incorporated herein by reference thereto.

### FIELD OF THE INVENTION

The invention relates to a method for welding a first composite sheet metal part comprising at least two metal sheets and a sheet arranged between both metal sheets that consists of a material with a different chemical composition than the two metal sheets, to a second sheet metal part consisting of a solid metallic material or a further composite material with at least two metal sheets and a sheet arranged the metal sheets that consists of a material with a different chemical composition than the two metal sheets. In addition, the invention relates to a welded semi-finished product and a welded sheet metal construction produced by the method according to the invention.

### BACKGROUND OF THE INVENTION

Composite sheet metal parts consist of a composite material with at least one sheet arranged between two metal sheets, which consists of a material with a different chemical composition than the two metal sheets. This intermediate sheet can also have a different thermal conductivity, density, melting and vaporisation point, strength and/or electrical conductivity than the two metal sheets. In the automotive industry composite materials with an intermediate sheet of for example a plastic material can be used to achieve a lighter construction. These composite materials are often fabricated in the form of so-called sandwich sheets. Such sandwich sheets have a good damping effect on structure-borne sound waves and are, therefore, suitable for damping airborne sound and also structure-borne sound, for example from engines. The core sheet of the composite sheet metal parts can comprise a viscoelastic plastic material that absorbs the vibrations. In the transmission of the vibrations to the sheet metal, a large part of the vibrational energy is converted into heat, with the result that the sound waves are damped. Particular areas of use of these composite sheet metal parts are oil sumps, valve and gear mechanism covers, and also for example bulkheads. Other areas of use are, however, also feasible, for example to enclose sources of noise. In order to provide corresponding structural parts the composite sheet metal parts comprising at least two metal sheets and an intermediate sheet, for example a plastic sheet, arranged between both metal sheets must be able to be joined to other structural parts. In principle, joining methods such as inert-gas welding, laser beam welding or soldering are suitable for this purpose. However, with a large heat input the plastic sheet is damaged or is destroyed in the welding zone regions. From DE 42 21 251 A1 a method is known for welding sheet metal parts consisting of a composite material comprising at least two metal sheets and a plastic sheet arranged between both metal sheets, in which this composite sheet metal part is joined to a full metal sheet using a laser welding method. Laser welding equipment is, however, not only very cost-intensive but destroys the plastic sheet in the region of the weld seam, so that a pore-free welded joint can be produced only with considerable effort. A virtually pore-free welded joint is, however, necessary in order to ensure a high weld seam quality and, therefore, a high operational strength and corrosion resistance of the weld seam.

### SUMMARY OF THE INVENTION

Against this background the object of the present invention is to provide a method for welding composite sheet metal parts comprising at least two metal sheets and a sheet arranged between both metal sheets, which consists of a material with a different chemical composition than the two metal sheets, to a second sheet metal part consisting of a solid metallic material or a further composite material with at least two metal sheets and a sheet arranged between the metal sheets, which consists of a material with a different chemical composition than the two metal sheets, with which pore-free welded joints can be produced with a high process reliability. In addition, a welded semi-finished product and a welded sheet metal construction with pore-free weld seams are proposed.

According to a first teaching of the present invention the aforementioned object is achieved if the sheet metal parts are welded using a high-frequency welding method.

In high-frequency welding a high-frequency alternating current is generated in the composite sheet metal part. This current is conducted on account of the skin effect and the proximity effect to the surface of the sheet metal part. Only in this way it is specifically possible to generate a concentrated current on the surface of the edges of the metal sheets of the composite sheet metal part by very high current densities, resulting in a selective and very appreciable heating of the sheet metal edges, so that the edge regions of the composite sheet metal parts can be joined to other sheet metal edges of other composite sheet metal parts or sheet metal parts of solid material. The sheet arranged between the metal sheets, which consists of a material with a different chemical composition than the two metal sheets and is preferably a plastic sheet, is not heated primarily, as for example in the case of laser welding, but simply secondarily via the heated metal sheets. Accordingly the intermediate sheet, preferably the plastic sheet, is not destroyed or vaporised to the same extent as in laser welding. Since in principle a smaller amount of for example plastic material is vaporised, as a result a virtually pore-free welded joint can be produced by welding composite sheet metal parts to other composite sheet metal parts or metal sheets of solid material.

According to a first modification of the method according to the invention the high-frequency welding method is performed conductively or inductively. In a conductive high-frequency welding method a high-frequency current is fed via an electrical contact to the metal structural parts to be welded or to the edge regions of the metal structural parts to be welded. In contrast to this, in inductive high-frequency welding the generation of the high-frequency current in the metal structural part takes place in a contact-less manner via suitably arranged induction conductors. In conductive high-frequency welding sliding contacts are used for example.

The composite sheet metal parts and the second sheet metal part can preferably be in strip form, wherein the welding of the sheet metal parts is carried out continuously in a strip-wise manner. The composite sheet metal part and the second sheet metal part are in this case provided via coils consisting of the respective composite material or sheet metal material, which are uncoiled and continuously welded. A tailored strip consisting of a first composite material and a solid material or a further composite material can be produced in this way. The thus produced tailored strip can be wound into a coil and then used for an inexpensive strip-wise fabrication of sound-insulating structural parts.

According to a further modification of the method according to the invention the welding is carried out in the butt joint or in the T-joint. In both welded joints use can be made of the fact that the edge regions of the composite sheet metal part can be heated extremely well via the high-frequency welding and can be welded to other sheet metal parts without seriously affecting the intermediate sheet, preferably the plastic sheet.

Preferably, the edge surfaces of the composite sheet metal part and those of the further sheet metal parts are heated at the welding joint edges to a temperature so that the metal sheets are at least plasticised. In this state the sheet metal parts are pressed against one another with a force in such a way that the at least plasticised metallic material of the first composite sheet metal part is displaced vertically to the applied force. The displacement of the metallic material can take place outwardly and/or inwardly. This displacement of the components of the sheet metal part enables the composite sheet metal part to be brought into contact with the second sheet metal part so that the for example receding intermediate sheet, preferably the plastic sheet of the composite sheet metal part, can come into direct contact in a simple manner with the second sheet metal part. The process reliability with which a pore-free weld seam can be produced is thereby further increased.

If the first sheet metal part is welded in the butt joint to a second sheet metal part of a solid metallic material and if the metallic material of the second sheet metal part is upset into the intermediate sheet, preferably the plastic sheet, and against the metal sheet of the composite material of the first sheet metal part, the formation of pores and air inclusions in the region of the weld seam can also be significantly reduced also when welding composite sheet metal parts to sheet metal parts of solid material.

An optically pleasing weld seam can then be prepared in a simple manner if the resultant weld seam bulge is mechanically removed or machined. The weld seam bulge can for example simply be flattened or completely removed by for example a grinding method.

With the method according to the invention composite sheet metal parts can then be provided with sheet metal parts or also with further composite sheet metal parts for a whole range of different applications if, according to a further modification of the method according to the invention, the first sheet metal part consists of steel sheets with a thickness of 0.25 mm to 1.5 mm and a plastic sheet with a thickness of 20 μm to 200 μm, preferably 80 μm to 150 μm. These sandwich sheet metal parts can be employed in many areas of use, in particular in automotive construction. This area of application is additionally broadened by the welding method according to the invention.

According to a second teaching of the present invention the object mentioned above is achieved by a welded semi-finished product, comprising at least a first sheet of a composite material with two metal sheets and a sheet arranged between the two metal sheets that consists of a material with a different chemical composition than the two metal sheets, and a second sheet metal part of a solid metallic material or a composite material with two metal sheets and a sheet arranged between both metal sheets that consists of a material with a different chemical composition than the two metal sheets, wherein the first and the second sheet metal parts are welded to one another using the high-frequency welding method. As already previously mentioned, the weld seam quality of the semi-finished product and of the sheet metal constructions that have been produced by the method according to the invention is particularly high since these can be fabricated with a high process reliability in a pore-free manner. Further areas of application in automotive construction and also in other sectors are thereby opened up for welded semi-finished product and sheet metal constructions fabricated therefrom.

The composite sheet metal parts can exhibit both a symmetrical and an asymmetrical structure. The welded semi-finished products can be of the same thickness or different thicknesses, in which case they then exhibit a stepped structure on one or both sides.

If the composite sheet metal part and the second sheet metal part comprise metal sheets consisting of different metal or steel materials or metal or steel sheet thicknesses, the semi-finished product can be optimised specifically for different areas of application.

Finally, the object mentioned above can be achieved by a sheet metal construction comprising a semi-finished product according to the invention, in which the welded sheet metal construction is an airborne or structure-borne sound damping structural part of a vehicle. As already mentioned before, the composite sheet metal parts have extremely good airborne and structure-borne sound damping properties. Bulkheads, floor metal sheets, oil sumps, etc. can thus be produced with good structure-borne sound and airborne sound damping properties and with a high weld seam quality.

### BRIEF DESCRIPTION OF THE DRAWINGS

The invention will be described in more detail hereinafter with the aid of exemplary embodiments in conjunction with the drawings in which:

FIG. 1a), b) shows in a schematic sectional view the field line distribution in the edge regions of two composite sheet metal parts to be joined when subjected to a high-frequency current, at the moment of contact in the butt joint and after contact,

FIG. 2 is an exemplary embodiment of a sheet metal construction fed with current and produced by the method according to the invention, before the mechanical processing,

FIG. 3 shows the welded sheet metal construction of FIG. 2 after a mechanical processing of the weld seam,

FIG. 4 shows the strip-wise welding according to a further exemplary embodiment of the method according to the invention, and

FIG. 5a), b) is a further exemplary embodiment of a welded sheet metal construction before and after the mechanical processing of the weld seam.

### DETAILED DESCRIPTION OF THE INVENTION

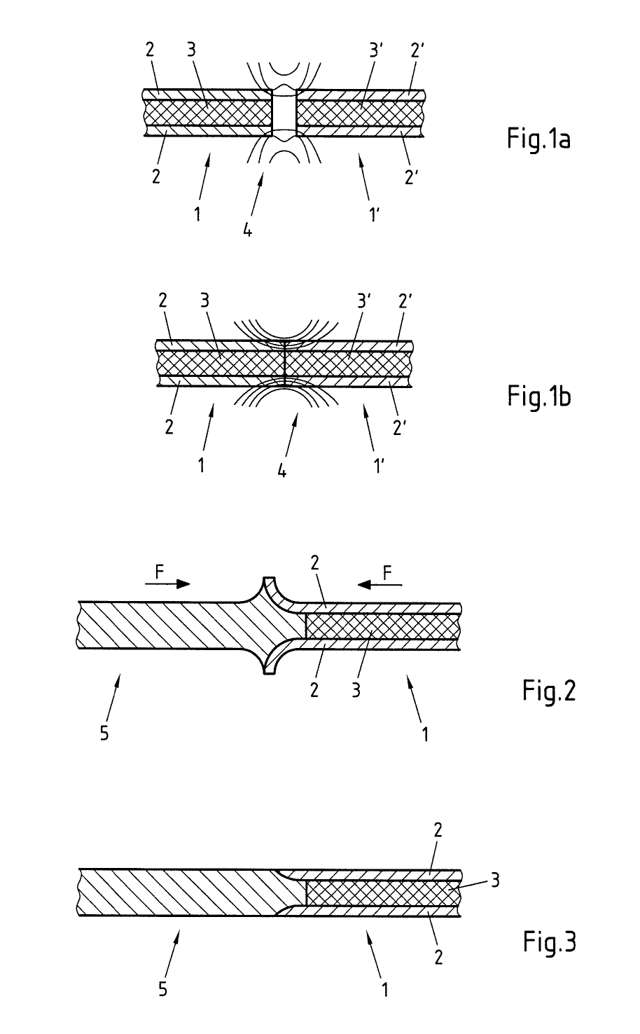

FIG. 1a), b) shows in a schematic sectional view a first and a second composite sheet metal part 1, 1′, which comprise respectively two metal sheets 2, 2′ and a plastic sheet 3, 3′ arranged between the metal sheets. Instead of the intermediate sheet of plastic material 3, 3′ illustrated in this exemplary embodiment, an arbitrary intermediate layer 3, 3′ can also be arranged, whose chemical composition differs from that of the metal sheets 2, 2′. In FIG. 1a), b) the metal sheet 2, 2′ and the plastic sheet 3, 3′ are shown not to scale. The sheet thicknesses of the plastic sheet 3, 3′ are about 20 μm to 200 μm and of the metal sheet 2, 2′ are about 0.25 mm to 1.5 mm. The composite sheet metal parts 1, 1′ are charged with a high-frequency current in different positions before and during the contacting. The field line pattern 4 in the edge region of the composite sheet metal part shows that the field lines are concentrated at the edge regions and accordingly lead to a high-frequency current density in the edge region. It had been recognised that when these composite sheet metal parts 1, 1′ are subjected to a high-frequency current the edge regions of the metal sheets of the composite sheet metal part become extremely hot. The plastic material in the plastic sheet 3, 3′ lying there between is heated only secondarily by the adjoining metal sheets 2, 2′, i.e. it is heated only by thermal conduction from the metal sheet 2, 2′. A direct heating of the plastic sheet 3, 3′ as it occurs in laser welding or other welding methods does not take place in high-frequency welding of composite sheet metal parts with an interposed plastic sheet. The secondary heating of the plastic sheet 3, 3′ is advantageous insofar as a complete vaporisation of the plastic layer 3, 3′ in the weld seam can be prevented when welding composite sheet metal parts having a corresponding sandwich construction. The resultant weld seam can accordingly be produced without pores and cavities.

FIG. 2 shows the production of a welded joint according to an exemplary embodiment of the method according to the invention, in which a composite sheet metal part 1 is joined to a second sheet metal part 5 consisting of a solid material. After heating the edge regions by a high-frequency current, so that these are plasticised, the edges in the butt joint can be pressed together with a force F so that the metal sheets 2 of the composite sheet metal part 1 are displaced outwardly. Despite the secondary heating of the plastic sheet 3, only a non-relevant part of the plastic sheet can vaporise. By pressing the two sheet metal parts 1 and 5 together, the inner part of the sheet metal part 5 is forced from the inside against the metal sheets 2 of the composite sheet metal part 1. On account of the plasticised consistency of the edges of the metal sheets of the composite sheet metal part and of the second sheet metal part, a cohesive joint is formed between the metal sheets of the composite sheet metal part 1 and the metal of the sheet metal part 5. The weld seam, which can be produced virtually pore-free with a high process reliability, can then be mechanically machined, for example planed. As a result a flat weld seam is formed with a material distribution as illustrated in the schematic sectional view in FIG. 3. The correspondingly constructed weld seam ensures an extremely good load-bearing welded joint between a composite sheet metal part 1 and a solid material sheet 5.

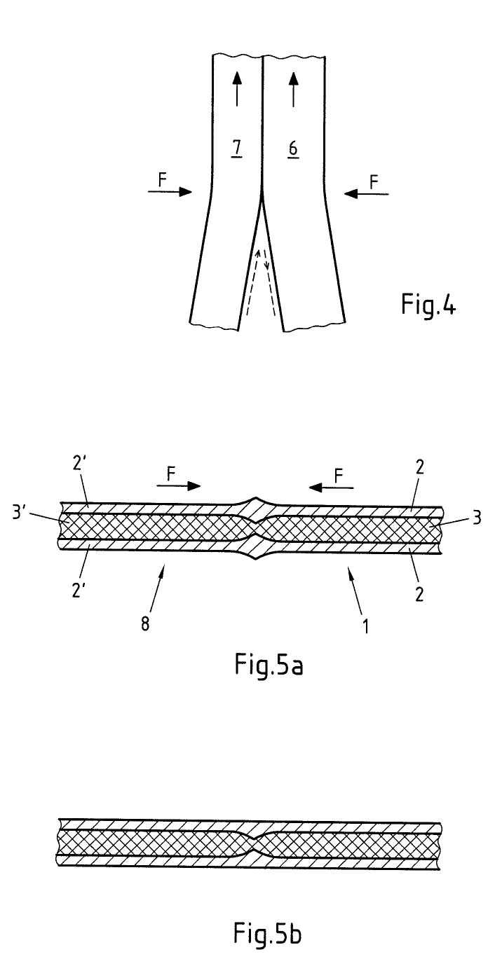

The strip-wise welding of a strip material 6 for a composite sheet metal part 1 to a strip material 7 of a sheet metal part of solid material is illustrated diagrammatically in FIG. 4. A simple strip-wise welding can be performed via high-frequency currents running along the edges of the strip material 7, 6, so that correspondingly welded semi-finished products consisting of a composite sheet metal part 1 and for example a sheet metal part 5 of solid material can be produced very economically. For this purpose the strips are pressed together at the weld point, for example using laterally mounted rollers, so that the edges of the metal sheets of the strip of composite material weld to the edges of the strip of solid materials. The same obviously also applies to the welding of two composite sheet metal parts, as is illustrated in FIGS. 5a) and b).

FIG. 5a) shows a schematic sectional view of a first composite sheet metal part 1 with its metal sheets 2 and the plastic sheet 3 lying there between, during the welding. A further composite sheet metal part 8 with metal sheets 2′ and a plastic sheet 3′ arranged there between are pressed against one another by applying a force F in the edge region after heating with a high-frequency current, so that the outer metal sheets are displaced outwardly and at the same time form a cohesive connection. The plastic sheets 3 and 3′ are pressed firmly against one another, so that the plastic material that inevitably vaporises during the welding does not lead to the formation of pores. As already illustrated in FIG. 3, the weld seam can then be mechanically machined and the weld bulge can be removed, so that a welded structural part is produced as illustrated in a schematic sectional view in FIG. 5b).

The joining of composite sheet metal parts to sheet metal parts of solid material opens up wide areas of use of the composite sheet metal parts, in particular in automotive construction in the area of floor metal sheets, oil sumps, bulkheads, etc.

1. Method for welding a composite structure, comprising welding a first composite sheet metal part comprising at least two metal sheets and a plastic sheet arranged between both metal sheets, to a second sheet metal part comprising a solid metallic material or a further composite sheet metal part with at least two metal sheets and a plastic sheet arranged between the metal sheets using a high-frequency welding method.

2. Method according to claim 1, wherein the high-frequency welding method is carried out conductively or inductively.

3. Method according to claim 1, wherein the first composite sheet metal part and the second sheet metal part are strip-shaped and the welding is carried out continuously in a strip-wise manner.

4. Method according to claim 1 wherein the welding is carried out in a butt joint or in a T-joint formed between the first composite sheet metal part and the second sheet metal part.

5. Method according to claim 1, wherein edge surfaces of the first composite sheet metal part and edge surfaces of the second sheet metal part are heated at weld butt edges to a temperature so that portions thereof are at least plasticized and the first composite sheet metal part and the second sheet metal part can be pressed together in this state with a force in such a way that the at least plasticized metallic material of the first composite sheet metal part is displaced perpendicularly to the applied force.

6. Method according to claim 5, wherein the first composite sheet metal part is welded in a butt joint to the second sheet metal part comprising a solid metallic material, and the metallic material of the second sheet metal part is forced into the plastic sheet and against the metal sheets of the composite sheet metal part.

7. Method according to claim 1, wherein a resultant weld seam bulge is mechanically removed or machined.

8. Method according to claim 1 wherein the first composite sheet metal part comprsises steel sheets with a thickness of 0.25 mm to 1.5 mm and a plastic sheet with a thickness of 20 μm to 200 μm, preferably 80 μm to 150 μm.

9. Welded semi-finished product comprising at least a first composite sheet metal part comprising two metal sheets and a plastic sheet arranged between both metal sheets, and a second sheet metal part of solid metallic material or a composite material with two metal sheets and a plastic sheet arranged between both metal sheets, wherein the first composite sheet metal part and the second sheet metal part are welded using the method of claim 1.

10. Welded semi-finished product according to claim 9, wherein the first composite sheet metal part and the second sheet metal part are of different metal or steel materials or have different metal or steel sheet thicknesses.

11. Welded sheet metal construction comprising a semi-finished product according to claim 9, wherein the welded sheet metal construction is an airborne or structure-borne sound damping structural part of a vehicle.

12. Welded sheet metal construction according to claim 11, wherein the welded sheet metal construction is part of a floor assembly of a vehicle body, a bulkhead, or an oil sump.
